(19) United States
(12) Patent Application Publication
(10) Pub. No.: US 2026/0288115 A1
(43) Pub. Date: Sep. 24, 2026

(54) NUMERICAL CONTROL DEVICE

(71) Applicant: FANUC CORPORATION, Yamanashi (JP)

(72) Inventor: Daisuke UENISHI, Yamanashi (JP)

(73) Assignee: FANUC CORPORATION, Yamanashi (JP)

(21) Appl. No.: 19/477,482

(22) PCT Filed: May 9, 2023
(86) PCT No.: PCT/JP2023/017479

§ 371 Date: Oct. 21, 2025

(51) Int. Cl. G05B 19/4155; G05B 19/402

(52) U.S. Cl. CPC G05B 19/4155; G05B 19/402; G05B 2219/34175

(57) ABSTRACT

The present invention provides a numerical control device capable of efficiently shortening a cycle time in consideration of interference between a workpiece or jig and a tool. The numerical control device comprises: a storage unit; and an overlap control unit. The overlap control unit causes two continuous machining operations to overlap each other on the basis of a machining program, and executes an overlap operation on a path where the tool and the workpiece or jig do not interfere with each other. The overlap control unit performs control so as to change an amount of overlap between the two continuous machining operations according to the machining operations.

### TECHNICAL FIELD

The present disclosure relates to a numerical control device.

### BACKGROUND ART

Conventionally, in a numerical control device used for operations such as drilling, tapping, and milling in a machine tool, the cycle time is shortened by utilizing an overlap function to smoothly connect positioning, rapid traverse, and cutting feed. As such a technique, for example, Patent Document 1 discloses a related technology.

### CITATION LIST

### Patent Document

Patent Document 1: Japanese U.S. Pat. No. 7,015,423

### DISCLOSURE OF THE INVENTION

### Problems to be Solved by the Invention

In the overlap function, the cycle time is shortened by uniformly determining the amount of overlap. However, depending on the machining operation, interference may occur between the workpiece or jig and the tool. Therefore, it is necessary to vary the amount of overlap in accordance with the machining operation.

Particularly in milling and operations within a fixed cycle, the degree of interference between the workpiece or jig and the tool differs significantly. Thus, it is required to differentiate the amount of overlap for both milling and fixed-cycle operations. Accordingly, a numerical control device is desired that enables efficient reduction of cycle time while taking into account interference between the workpiece or jig and the tool.

### Means for Solving the Problems

One aspect of the present disclosure provides a numerical control device for a machine tool that causes relative movement between a tool and a workpiece or jig, and machines the workpiece with the tool. The numerical control device includes: a storage unit configured to store a machining program for causing the machine tool to perform machining operations including fixed-cycle machining and non-fixed-cycle machining; and an overlap control unit configured to control the relative movement between the tool and the workpiece or the jig, based on the machining program. The overlap control unit causes two successive machining operations to overlap based on the machining program, and executes an overlapping operation along a path on which the tool and the workpiece or the jig do not interfere with each other. The overlap control unit is further configured to vary the amount of overlap of the two successive machining operations in accordance with the machining operation.

### BRIEF DESCRIPTION OF THE DRAWINGS

FIG. 1 is a block diagram illustrating a configuration of a machining system according to the present embodiment;

FIG. 2A is a diagram illustrating an example of an overlap corresponding to a non-fixed-cycle operation;

FIG. 2B is a diagram illustrating an example of an overlap corresponding to an operation within a fixed cycle;

FIG. 2C is a diagram illustrating another example of an overlap corresponding to an operation within a fixed cycle;

FIG. 3 is a table illustrating an example of an amount of overlap; and

FIG. 4 is a flowchart illustrating an example of the processing for setting an amount of overlap.

### PREFERRED MODE FOR CARRYING OUT THE INVENTION

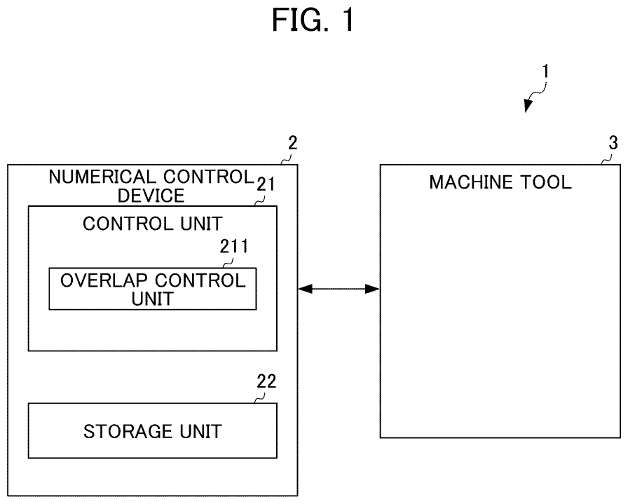

Hereinafter, an example of an embodiment of the present disclosure will be described. FIG. 1 is a block diagram illustrating the configuration of a machining system 1 according to the present embodiment. As illustrated in FIG. 1, the machining system 1 includes a numerical control device 2 and a machine tool 3.

The numerical control device 2 is a device for causing the machine tool 3 to perform predetermined machining or the like by controlling the machine tool 3. The numerical control device 2 includes a control unit 21 and a storage unit 22.

The control unit 21 is a processor such as a CPU (Central Processing Unit), and functions as various functional units (for example, an overlap control unit 211) by executing programs stored in the storage unit 22.

The storage unit 22 is a storage device including a ROM (Read Only Memory) storing an OS (Operating System), application programs, and the like, a RAM (Random Access Memory), and other storage devices such as a hard disk drive or SSD (Solid State Drive) that store various kinds of information.

The machine tool 3 is a device that performs predetermined machining such as drilling, tapping, milling, and cutting, as well as tool measurement, under the control of the numerical control device 2. The machine tool 3 causes relative movement between a tool and a workpiece or jig, and machines the workpiece by using the tool.

The machine tool 3 includes a motor that drives for machining the workpiece, a spindle and feed shafts to which the motor is attached, a jig and a tool corresponding to each of these shafts, and a table for fixing the workpiece. The machine tool 3 performs predetermined machining by driving the motor in accordance with operation commands output from the numerical control device 2.

Next, the overlap-related operation of the numerical control device 2 will be described. In the present embodiment, the storage unit 22 stores a machining program for causing the machine tool 3 to perform machining operations including fixed-cycle machining and non-fixed-cycle machining. The overlap control unit 211 controls the relative movement between the tool and the workpiece or jig, based on the machining program.

The overlap control unit 211 causes two successive machining operations to overlap based on the machining program, and executes an overlapping operation along a path on which the tool and the workpiece or the jig do not interfere with each other. Further, the overlap control unit 211 controls so as to vary the amount of overlap of the two successive machining operations in accordance with the machining operation.

The storage unit 22 stores at least two different amounts of overlap corresponding to respective machining operations. The overlap control unit 211 reads an amount of overlap corresponding to the machining operation from the storage unit 22, and applies the read amount of overlap to the overlapping operation corresponding to the machining operation.

More specifically, the storage unit 22 stores a first amount of overlap corresponding to a non-fixed-cycle operation, a second amount of overlap corresponding to an initial point return operation within a fixed cycle, and a third amount of overlap corresponding to a reference point return operation within a fixed cycle.

The overlap control unit 211 reads one of the first amount of overlap, the second amount of overlap, and the third amount of overlap from the storage unit 22 in accordance with the machining operation, and applies the read amount of overlap to the overlapping operation corresponding to the machining operation. Here, the amounts of overlap are in the order of the first, second, and third amounts of overlap in decreasing order of magnitude.

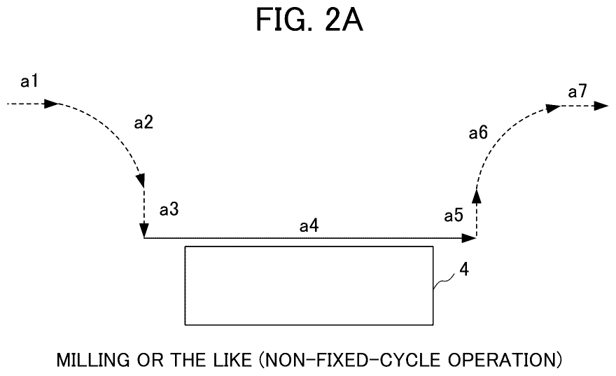

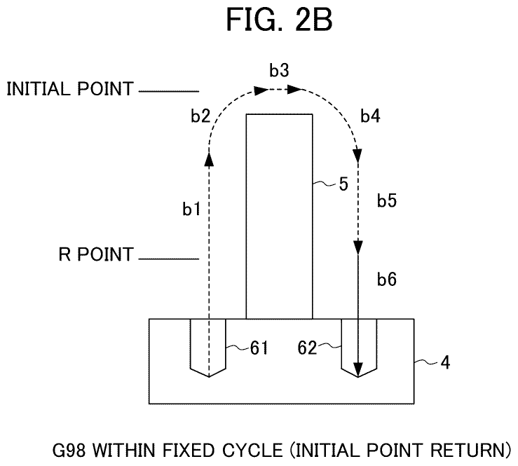

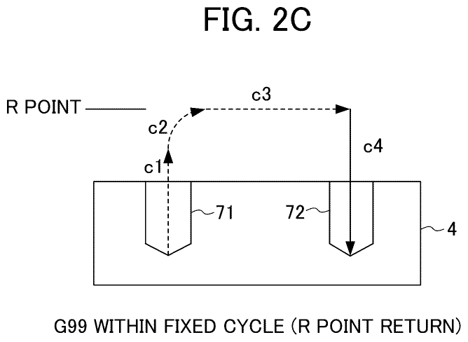

FIGS. 2A to 2C are diagrams for illustrating the control for varying the amount of overlap. FIG. 2A illustrates the first amount of overlap corresponding to a non-fixed-cycle operation. Examples of non-fixed-cycle operations include, for instance, milling.

As illustrated in FIG. 2A, in a non-fixed-cycle operation, the tool moves along the paths a1 to a7. The overlapping operation is executed on the paths a2 and a6, and the machining operation for machining the workpiece 4 is executed on path a4. The aforementioned first amount of overlap corresponds to the overlapping operation executed on the paths a2 and a6.

FIG. 2B illustrates the second amount of overlap corresponding to an initial point return operation within a fixed cycle. As illustrated in FIG. 2B, in an initial point return operation (G code: G98) within a fixed cycle, the tool moves along the paths b1 to b6 from a hole 61 to a hole 62 in the workpiece 4. Since a jig 5 exists between the holes 61 and 62, the tool needs to move in a manner that avoids contact with the jig 5. The tool reaches the initial point via the paths b2 to b4, and the overlapping operation is executed on the paths b2 and b4. The aforementioned second amount of overlap corresponds to the overlapping operation executed on the paths b2 and b4.

FIG. 2C illustrates the third amount of overlap corresponding to a reference point return operation within a fixed cycle. As illustrated in FIG. 2C, in an R point return operation (G code: G99) within a fixed cycle, the tool moves along the paths c1 to c4 from a hole 71 to a hole 72 in the workpiece 4. The tool reaches the R point via the paths c2 and c3, and the overlapping operation is executed on path c2. The aforementioned third amount of overlap corresponds to the overlapping operation executed on path c2.

The amount of overlap may be a set distance at which each axis of the machine tool 3 should start an overlapping operation. For example, when the amount of overlap is set to a distance of 10 mm, the X-axis of the machine tool 3 starts the overlapping operation when the remaining operation distance of the Y-axis of the machine tool 3 reaches 10 mm.

Alternatively, the amount of overlap may be a set distance at which each axis of the machine tool 3 can start an overlapping operation. For example, even if the amount of overlap is set to a distance of 10 mm, the X-axis of the machine tool 3 does not necessarily have to start the overlapping operation when the remaining operation distance of the Y-axis of the machine tool 3 reaches 10 mm. Instead, for example, the X-axis of the machine tool 3 may start the overlapping operation when the remaining operation distance of the Y-axis of the machine tool 3 becomes 5 mm.

The storage unit 22 may store a plurality of different amounts of overlap in advance, and the overlap control unit 211 may analyze the machining program and apply any one of the plurality of different amounts of overlap stored in the storage unit 22 to the overlapping operation, based on a control signal during the machining operation.

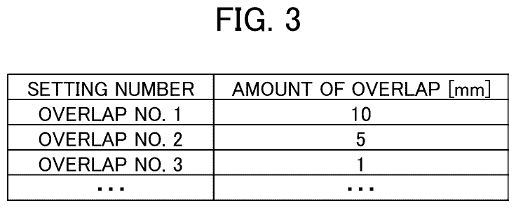

FIG. 3 illustrates examples of a plurality of different amounts of overlap. As illustrated in FIG. 3, overlap setting numbers (Overlap No. 1, No. 2, . . . ) are associated with respective amounts of overlap (10 mm, 5 mm, . . . ).

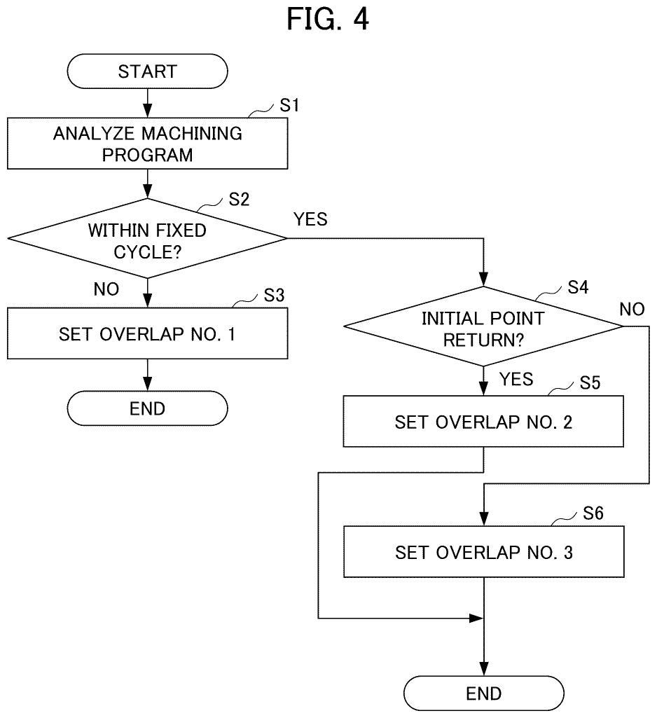

FIG. 4 is a flowchart illustrating the processing for applying one of the amounts of overlap to the overlapping operation. In Step S1 of FIG. 4, the overlap control unit 211 reads a machining program corresponding to the machining operation from the storage unit 22, and analyzes the machining program.

In Step S2, the overlap control unit 211 determines whether the machining operation in the analyzed machining program is a fixed-cycle operation. If the machining operation is a fixed-cycle operation (YES), the processing proceeds to Step S4. If the machining operation is not a fixed-cycle operation (NO), the processing proceeds to Step S3.

In Step S3, the overlap control unit 211 sets overlap setting number No. 1 corresponding to the non-fixed-cycle operation, and sets 10 mm as the amount of overlap corresponding to overlap setting number No. 1 from the storage unit 22 (see FIG. 3).

In Step S4, the overlap control unit 211 determines whether the machining operation in the analyzed machining program is an initial point return (G98). If the machining operation is an initial point return (YES), the processing proceeds to Step S5. If the machining operation is not an initial point return (NO), the processing proceeds to Step S6.

In Step S5, the overlap control unit 211 sets overlap setting number No. 2 corresponding to the initial point return, and sets 5 mm as the amount of overlap corresponding to overlap setting number No. 2 from the storage unit 22 (see FIG. 3).

In Step S6, the overlap control unit 211 sets overlap setting number No. 3 corresponding to the R point return, and sets 1 mm as the amount of overlap corresponding to overlap setting number No. 3 from the storage unit 22 (see FIG. 3).

In the embodiment described above, the overlapping operation has been described with respect to non-fixed-cycle operations, initial point return operations within a fixed cycle, and reference point return operations within a fixed cycle. However, the overlapping operation may correspond to other operations as well. For example, the overlapping operation may be performed during a tool change operation.

Further, the overlap control unit 211 may, instead of analyzing the machining program, set the amount of overlap in accordance with a control signal received from an external device. For example, when a robot is present in the vicinity of the numerical control device 2, setting a large amount of overlap may result in interference between the numerical control device 2 and the robot. Therefore, when the overlap control unit 211 receives, from an external device, a control signal indicating the presence of a robot near the numerical control device 2, the overlap control unit 211 may set the amount of overlap to a smaller value.

According to the present embodiment, the numerical control device 2 includes: the storage unit 22 that stores a machining program for causing the machine tool 3 to execute machining operations including fixed-cycle machining and non-fixed-cycle machining; and the overlap control unit 211 that controls the relative movement between the tool and the workpiece or jig, based on the machining program. The overlap control unit 211 causes two successive machining operations to overlap based on the machining program, and executes the overlapping operation along a path on which the tool and the workpiece or the jig do not interfere with each other. Further, the overlap control unit 211 controls so as to vary the amount of overlap of the two successive machining operations in accordance with the machining operation. Thus, the numerical control device 2 enables efficient reduction of the cycle time while taking into account interference between the workpiece or jig and the tool.

The overlap control unit 211 reads an amount of overlap corresponding to a machining operation from the storage unit 22, and applies the read amount of overlap to the overlapping operation corresponding to the machining operation. This enables the numerical control device 2 to apply an amount of overlap corresponding to the machining operation to the overlapping operation.

The overlap control unit 211 reads one of the first amount of overlap, the second amount of overlap, and the third amount of overlap from the storage unit 22 in accordance with the machining operation, and applies the read amount of overlap to the overlapping operation corresponding to the machining operation. The amounts of overlap are in the order of the first, second, and third amounts of overlap in decreasing order of magnitude. This enables the numerical control device 2 to set an amount of overlap corresponding to a non-fixed-cycle operation, an initial point return operation within a fixed cycle, and a reference point return operation within a fixed cycle.

The amount of overlap may be a set distance at which each axis of the machine tool 3 should start the overlapping operation. Alternatively, the amount of overlap may be a set distance at which each axis of the machine tool 3 can start the overlapping operation. This enables the numerical control device 2 to appropriately set the distance for starting the overlapping operation.

The storage unit 22 may store a plurality of different amounts of overlap in advance, and the overlap control unit 211 may analyze the machining program and apply any one of the plurality of different amounts of overlap stored in the storage unit 22 to the overlapping operation, based on a control signal during the machining operation. This enables the numerical control device 2 to apply any one of the plurality of different amounts of overlap to the overlapping operation and to efficiently reduce the cycle time while taking interference into account.

Although the embodiment of the present invention has been described above, the numerical control device 2 described above may be implemented by hardware, software, or a combination thereof. In addition, the control method executed by the numerical control device 2 may also be implemented by hardware, software, or a combination thereof. Here, implementation by software means that a computer implements the functions by reading and executing a program.

The program can be stored using various types of non-transitory computer-readable media and provided to a computer. The non-transitory computer-readable medium includes various types of tangible storage media. Examples of non-transitory computer-readable media include magnetic recording media (e.g., hard disk drives), magneto-optical recording media (e. g., magneto-optical disks), CD-ROMs (Compact Disc Read-Only Memory), CD-Rs, CD-RWs, and semiconductor memories (e. g., mask ROMS, PROMs (Programmable ROMs), EPROMS (Erasable PROMs), flash ROMs, and RAM (Random Access Memory)).

The present disclosure has been described in detail; however, it is not limited to the individual embodiments described above. These embodiments may be subjected to various additions, replacements, modifications, and partial deletions without departing from the spirit of the present disclosure within the scope of the claims or the equivalents thereof. Furthermore, the embodiments may be implemented in combination. For example, in the above-described embodiments, the order of the operations and the order of the processing are merely exemplary and not limiting. The same applies to cases where numerical values or equations are used in the description of the embodiments.

Further additions related to the above-described embodiment and modified examples are disclosed below.

### Additional Note 1

A numerical control device (2) for a machine tool (3) that causes relative movement between a tool and a workpiece or jig, and machines the workpiece with the tool, including:
a storage unit (22) configured to store a machining program that causes the machine tool to perform machining operations including fixed-cycle machining and non-fixed-cycle machining; and
an overlap control unit (221) configured to control the relative movement between the tool and the workpiece or the jig, based on the machining program, in which
the overlap control unit causes two successive machining operations to overlap based on the machining program, and executes an overlapping operation along a path on which the tool and the workpiece or the jig do not interfere with each other, and
the overlap control unit is configured to vary the amount of overlap of the two successive machining operations in accordance with the machining operation.

### Additional Note 2

The numerical control device as described in Additional Note 1, in which
the storage unit stores at least two amounts of overlap corresponding to the machining operation, and
the overlap control unit reads the amount of overlap corresponding to the machining operation from the storage unit, and applies the read amount of overlap to the overlapping operation corresponding to the machining operation.

### Additional Note 3

The numerical control device as described in Additional Note 1 or 2, in which
the storage unit stores a first amount of overlap corresponding to a non-fixed-cycle operation, a second amount of overlap corresponding to an initial point return operation within a fixed cycle, and a third amount of overlap corresponding to a reference point return operation within a fixed cycle, and
the first, second, and third amounts of overlap are in decreasing order of magnitude.

### Additional Note 4

The numerical control device as described in Additional Note 1 or 2, in which
the amount of overlap is a set distance at which each axis of the machine tool should start the overlapping operation.

### Additional Note 5

The numerical control device as described in Additional Note 1 or 2, in which
the amount of overlap is a set distance at which each axis of the machine tool can start the overlapping operation.

### Additional Note 6

The numerical control device as described in Additional Note 1, in which
the storage unit stores a plurality of different amounts of the overlap in advance, and
the overlap control unit analyzes the machining program and applies any one of the plurality of different amounts of overlap stored in the storage unit to the overlapping operation, based on a control signal during the machining operation.

### EXPLANATION OF REFERENCE NUMERALS

1: machining system
2: numerical control device
3: machine tool
21: control unit
22: storage unit
211: overlap control unit

1. A numerical control device for a machine tool that causes relative movement between a tool and a workpiece or jig, and machines the workpiece with the tool, the numerical control device comprising:
a storage unit configured to store a machining program for causing the machine tool to perform a machining operation including a fixed-cycle operation and a non-fixed-cycle operation; and
an overlap control unit configured to control the relative movement between the tool and the workpiece or the jig, based on the machining program, wherein
the overlap control unit causes two successive machining operations to overlap based on the machining program, and executes an overlapping operation along a path on which the tool and the workpiece or the jig do not interfere with each other, and
the overlap control unit executes control to vary an amount of overlap of the two successive machining operations in accordance with the machining operation.

2. The numerical control device according to claim 1, wherein
the storage unit stores at least two amounts of overlap corresponding to the machining operation, and
the overlap control unit reads the amount of overlap corresponding to the machining operation from the storage unit, and applies the amount of overlap thus read to an overlapping operation corresponding to the machining operation.

3. The numerical control device according to claim 1, wherein
the storage unit stores a first amount of overlap corresponding to the non-fixed-cycle operation, a second amount of overlap corresponding to an initial point return operation within a fixed cycle, and a third amount of overlap corresponding to a reference point return operation within the fixed cycle, and
the first, second, and third amounts of overlap are in decreasing order of magnitude.

4. The numerical control device according to claim 1, wherein the amount of overlap is a set distance at which each axis of the machine tool should start the machining operation.

5. The numerical control device according to claim 1, wherein the amount of overlap is a set distance at which each axis of the machine tool can start the machining operation.

6. The numerical control device according to claim 1, wherein
the storage unit stores a plurality of different amounts of the overlap in advance, and
the overlap control unit analyzes the machining program and applies any one of the plurality of different amounts of the overlap stored in the storage unit to the overlapping operation, based on a control signal during the machining operation.
